(19) United States
(12) Patent Application Publication
(10) Pub. No.: US 2017/0135101 A1
(43) Pub. Date: May 11, 2017

(54) Method and Apparatus for Determining Data Transmission

(71) Applicant: Huawei Technologies Co., Ltd., Shenzhen (JP)

(72) Inventors: Bingzhao Li, Beijing (CN); Xiaodong Yang, Shenzhen (CN); Wei Quan, Beijing (CN); Jian Zhang, Beijing (CN)

(21) Appl. No.: 15/415,242

(22) Filed: Jan. 25, 2017

Related U.S. Application Data
(63) Continuation of application No. PCT/CN2014/083490, filed on Jul. 31, 2014.

(51) Int. Cl. H04W 72/04; H04L 5/00; H04L 12/24; H04L 5/14; H04W 72/12

(52) U.S. Cl. CPC H04W 72/0446; H04L 5/14; H04W 72/12; H04W 72/0406; H04L 41/0803; H04L 5/0055; H04W 88/02

(57) ABSTRACT

A method and apparatus for determining data transmission are disclosed. In an embodiment, the method includes determining, by a communication device, that a current subframe belongs to a first time segment, where the first time segment is a time segment in which scheduling is allowed on a secondary component carrier; and determining, by the communication device, data transmission of the current subframe.

### CROSS-REFERENCE TO RELATED APPLICATIONS

This application is a continuation of International Application No. PCT/CN2014/083490, filed on Jul. 31, 2014, the disclosure of which is hereby incorporated by reference in its entirety.

### TECHNICAL FIELD

The present invention relates to the field of mobile communications technologies, and in particular, to a method and an apparatus for determining data transmission.

### BACKGROUND

In a communications network based on a Long Term Evolution-time division duplex (LTE-TDD) system, multiple base stations use the same frequency resource, that is, transmit data by using one carrier. Data is transmitted between a base station and user equipment (UE) in different subframes in a TDD frame. An uplink subframe in the TDD frame is used to transmit uplink data, and a downlink subframe in the TDD frame is used to transmit downlink data.

In the prior art, when different base stations use one secondary component carrier to transmit data, these base stations need to contend with each other to obtain a time segment in which the base stations can transmit the data on the secondary component carrier. After a base station obtains a time segment in which the base station can transmit data, the base station may transmit scheduling information to UE according to a preset uplink-downlink configuration (indicating a proportion of uplink subframes to downlink subframes in one TDD frame) of a TDD frame of the secondary component carrier by using a physical downlink control channel (PDCCH) in a downlink subframe that is used to transmit the scheduling information. After receiving the scheduling information transmitted by the base station, the UE may transmit uplink data to the base station in some uplink subframes according to the uplink-downlink configuration and the scheduling information. The base station transmits, according to the uplink-downlink configuration and a situation about receiving the uplink data, feedback information corresponding to the situation about receiving the uplink data to the UE in a downlink subframe that is used to transmit the feedback information. Then, the UE determines, according to the feedback information corresponding to the situation about receiving the uplink data, whether to retransmit the uplink data in uplink subframes in a next TDD frame that have same numbers with the some uplink subframes.

However, multiple time segments that a base station obtains by means of contention may be inconsecutive. Therefore, if the foregoing downlink subframe that is used to transmit the scheduling information is located in a time segment that cannot be used by the base station, and the uplink subframe in which the UE transmits the uplink data to the base station is located in a time segment that can be used by the base station, the UE cannot transmit the uplink data to the base station in the uplink subframe that is in the time segment that can be used by the base station, because the base station cannot deliver the scheduling information to the UE. If the foregoing downlink subframe that is used to transmit the feedback information is located in a time segment that cannot be used by the base station, after the UE transmits the uplink data to the base station, the base station cannot transmit the feedback information corresponding to the situation about receiving the uplink data to the UE. As a result, the base station cannot normally communicate with the UE, and communication efficiency between the base station and the UE is reduced.

### SUMMARY

Embodiments of the present invention provide a method and an apparatus for determining data transmission, so that normal communication between a base station and UE can be ensured, thereby improving communication efficiency between the base station and the UE.

According to a first aspect, an embodiment of the present invention provides a communication device, including a determining unit, configured to determine that a current subframe belongs to a first time segment, where the first time segment is a time segment in which scheduling is allowed on a secondary component carrier; where the determining unit is further configured to determine data transmission of the current subframe.

In a first possible implementation manner of the first aspect, the determining unit is specifically configured to determine that the current subframe belongs to the first time segment, and a subframe 1 that meets a preset mapping relationship with the current subframe belongs to a second time segment, where the second time segment is a time segment in which scheduling is stopped on the secondary component carrier.

With reference to the first possible implementation manner of the first aspect, in a second possible implementation manner, the communication device further includes an obtaining unit, where the obtaining unit is configured to obtain a preset first uplink-downlink configuration before the determining unit determines that the current subframe belongs to the first time segment and the subframe 1 that meets the preset mapping relationship with the current subframe belongs to the second time segment.

With reference to the second possible implementation manner of the first aspect, in a third possible implementation manner, the mapping relationship is a scheduling relationship, where the determining unit is specifically configured to: determine, according to the first uplink-downlink configuration obtained by the obtaining unit, that the current subframe is a first uplink subframe and the subframe 1 is a first downlink subframe that meets the scheduling relationship with the first uplink subframe; determine, according to the first time segment and the second time segment that are obtained by the obtaining unit, that the first uplink subframe is an uplink subframe in the first time segment and the first downlink subframe is a downlink subframe in the second time segment; and determine to transmit downlink data in the first uplink subframe.

In a fourth possible implementation manner of the first aspect, the communication unit further includes a setting unit, where the determining unit is specifically configured to determine that the current subframe is the first subframe in the first time segment; the setting unit is configured to set a subframe number of the first subframe determined by the determining unit to a preset second subframe number, where the second subframe number is used to represent that the first subframe or a subframe 1 that meets a preset mapping relationship with the first subframe belongs to the first time segment; and the determining unit is specifically configured to determine data transmission of the first subframe according to the second subframe number set by the setting unit.

With reference to the fourth possible implementation manner of the first aspect, in a fifth possible implementation manner, the communication device further includes an obtaining unit, where the obtaining unit is configured to obtain a second uplink-downlink configuration before the determining unit determines the data transmission of the current subframe; and the determining unit is specifically configured to determine the data transmission of the first subframe according to the second subframe number set by the setting unit and the second uplink-downlink configuration obtained by the obtaining unit.

In a sixth possible implementation manner of the first aspect, the communication device further includes an obtaining unit, where the obtaining unit is configured to obtain a second uplink-downlink configuration before the determining unit determines the data transmission of the current subframe; and the determining unit is specifically configured to: determine that the current subframe is the first subframe in the first time segment, and determine data transmission of the first subframe according to the second uplink-downlink configuration obtained by the obtaining unit.

With reference to the first possible implementation manner of the first aspect, in a seventh possible implementation manner, the communication device is UE, and the mapping relationship is a feedback relationship, where the determining unit is specifically configured to determine, according to the first time segment and the second time segment that are obtained by the obtaining unit, that the first uplink subframe is an uplink subframe in the first time segment and the second downlink subframe is a downlink subframe in the second time segment; and the UE further includes a sending unit, where the sending unit is configured to: send uplink data to a base station in the first uplink subframe determined by the determining unit, and store the uplink data in a transmission cache; and the determining unit is further configured to determine that the base station correctly receives the uplink data sent by the sending unit.

With reference to the seventh possible implementation manner of the first aspect, in an eighth possible implementation manner, the determining unit is further configured to: after determining that the base station does not correctly receive the uplink data sent by the sending unit, determine a carrier indicator field CIF carried in scheduling information that is received in a third downlink subframe, where the CIF carries a process ID of the uplink data; and determine, according to the process ID, that the sending unit sends the uplink data to the base station in a third uplink subframe, where the third downlink subframe is a downlink subframe that is after the second downlink subframe and in which the third uplink subframe is scheduled, and the third uplink subframe is an uplink subframe that is in the first time segment and after the first uplink subframe and whose subframe number is closest to a subframe number of the first uplink subframe.

With reference to the first possible implementation manner of the first aspect, in a ninth possible implementation manner, the communication device is a base station, and the mapping relationship is a feedback relationship, where the determining unit is specifically configured to determine that the current subframe is a first uplink subframe, the subframe 1 is a second downlink subframe in which feedback information corresponding to the first uplink subframe is located, and the second downlink subframe is a downlink subframe in the second time segment.

With reference to the ninth possible implementation manner of the first aspect, in a tenth possible implementation manner, the base station further includes a receiving unit, where the determining unit is further configured to: after the receiving unit correctly receives the uplink data in the first uplink subframe, determine to skip sending the feedback information to the UE in the second downlink subframe.

With reference to the ninth possible implementation manner of the first aspect, in an eleventh possible implementation manner, the determining unit is further configured to: if the receiving unit does not correctly receive the uplink data in the first uplink subframe, determine that the sending unit sends scheduling information in a third downlink subframe, where the scheduling information is used to schedule a third uplink subframe, the scheduling information carries a CIF, and the CIF carries a process ID of the uplink data.

With reference to any one of the foregoing first aspect, or the first to the sixth possible implementation manners of the first aspect, in a twelfth possible implementation manner, the communication device is UE or a base station.

According to a second aspect, an embodiment of the present invention provides a communication device, including a processor, configured to: determine that a current subframe belongs to a first time segment, where the first time segment is a time segment in which scheduling is allowed on a secondary component carrier, and determine data transmission of the current subframe.

In a first possible implementation manner of the second aspect, the processor is specifically configured to determine that the current subframe belongs to the first time segment, and a subframe 1 that meets a preset mapping relationship with the current subframe belongs to a second time segment, where the second time segment is a time segment in which scheduling is stopped on the secondary component carrier.

With reference to the first possible implementation manner of the second aspect, in a second possible implementation manner, the processor is further configured to obtain a preset first uplink-downlink configuration before determining that the current subframe belongs to the first time segment and the subframe 1 that meets the preset mapping relationship with the current subframe belongs to the second time segment.

With reference to the second possible implementation manner of the second aspect, in a third possible implementation manner, the mapping relationship is a scheduling relationship, where the processor is specifically configured to: determine, according to the first uplink-downlink configuration, that the current subframe is a first uplink subframe and the subframe 1 is a first downlink subframe that meets the scheduling relationship with the first uplink subframe; determine, according to the first time segment and the second time segment, that the first uplink subframe is an uplink subframe in the first time segment and the first downlink subframe is a downlink subframe in the second time segment; and determine to transmit downlink data in the first uplink subframe.

In a fourth possible implementation manner of the second aspect, the processor is specifically configured to: determine that the current subframe is the first subframe in the first time segment; set a subframe number of the first subframe to a preset second subframe number, where the second subframe number is used to represent that the first subframe or a subframe 1 that meets a preset mapping relationship with the first subframe belongs to the first time segment; and determine data transmission of the first subframe according to the second subframe number.

With reference to the fourth possible implementation manner of the second aspect, in a fifth possible implementation manner, the processor is further configured to obtain a second uplink-downlink configuration before determining the data transmission of the current subframe; and the processor is specifically configured to determine the data transmission of the first subframe according to the second subframe number and the second uplink-downlink configuration.

In a sixth possible implementation manner of the second aspect, the processor is further configured to: before determining the data transmission of the current subframe, obtain a second uplink-downlink configuration, determine that the current subframe is the first subframe in the first time segment, and determine data transmission of the first subframe according to the second uplink-downlink configuration.

With reference to the first possible implementation manner of the second aspect, in a seventh possible implementation manner, the communication device is UE, and the mapping relationship is a feedback relationship, where the processor is specifically configured to determine, according to the first time segment and the second time segment, that the first uplink subframe is an uplink subframe in the first time segment and the second downlink subframe is a downlink subframe in the second time segment; and correspondingly, the UE further includes a transmitter, where the transmitter is configured to: send uplink data to a base station in the first uplink subframe determined by the processor, and store the uplink data in a transmission cache; and the processor is further configured to determine that the base station correctly receives the uplink data sent by the transmitter.

With reference to the seventh possible implementation manner of the second aspect, in an eighth possible implementation manner, the processor is further configured to: after determining that the base station does not correctly receive the uplink data sent by the transmitter, determine a carrier indicator field CIF carried in scheduling information that is received in a third downlink subframe, where the CIF carries a process ID of the uplink data; and determine, according to the process ID, that the transmitter sends the uplink data to the base station in the first uplink subframe, where the third downlink subframe is a downlink subframe that is after the second downlink subframe and in which the third uplink subframe is scheduled, and the third uplink subframe is an uplink subframe that is in the first time segment and after the first uplink subframe and whose subframe number is closest to a subframe number of the first uplink subframe.

With reference to the first possible implementation manner of the second aspect, in a ninth possible implementation manner, the communication device is a base station, and the mapping relationship is a feedback relationship, where the processor is specifically configured to determine that the current subframe is a first uplink subframe, the subframe 1 is a second downlink subframe in which feedback information corresponding to the first uplink subframe is located, and the second downlink subframe is a downlink subframe in the second time segment.

With reference to the ninth possible implementation manner of the second aspect, in a tenth possible implementation manner, the base station further includes a receiver, where the processor is further configured to: after the receiver correctly receives the uplink data in the first uplink subframe, determine to skip sending the feedback information to the UE in the second downlink subframe.

With reference to the ninth possible implementation manner of the second aspect, in an eleventh possible implementation manner, the processor is further configured to: if the receiver does not correctly receive the uplink data in the first uplink subframe, determine that the transmitter sends scheduling information in a third downlink subframe, where the scheduling information is used to schedule a third uplink subframe, the scheduling information carries a CIF, and the CIF carries a process ID of the uplink data.

With reference to any one of the foregoing second aspect, or the first to the sixth possible implementation manners of the second aspect, in a twelfth possible implementation manner, the communication device is UE or a base station.

According to a third aspect, an embodiment of the present invention provides a method for determining data transmission, including determining, by a communication device, that a current subframe belongs to a first time segment, where the first time segment is a time segment in which scheduling is allowed on a secondary component carrier; and determining, by the communication device, data transmission of the current subframe.

In a first possible implementation manner of the third aspect, the determining, by a communication device, that a current subframe belongs to a first time segment includes determining, by the communication device, that the current subframe belongs to the first time segment, and a subframe 1 that meets a preset mapping relationship with the current subframe belongs to a second time segment, where the second time segment is a time segment in which scheduling is stopped on the secondary component carrier.

With reference to the first possible implementation manner of the third aspect, in a second possible implementation manner, before the determining, by the communication device, that the current subframe belongs to the first time segment, and a subframe 1 that meets a preset mapping relationship with the current subframe belongs to a second time segment, the method further includes obtaining, by the communication device, a preset first uplink-downlink configuration.

With reference to the second possible implementation manner of the third aspect, in a third possible implementation manner, the mapping relationship is a scheduling relationship, where the determining, by the communication device, that the current subframe belongs to the first time segment, and a subframe 1 that meets a preset mapping relationship with the current subframe belongs to a second time segment includes determining, by the communication device according to the first uplink-downlink configuration, that the current subframe is a first uplink subframe and the subframe 1 is a first downlink subframe that meets the scheduling relationship with the first uplink subframe; and determining, according to the first time segment and the second time segment, that the first uplink subframe is an uplink subframe in the first time segment and the first downlink subframe is a downlink subframe in the second time segment; and correspondingly, the determining, by the communication device, data transmission of the current subframe includes determining, by the communication device, to transmit downlink data in the first uplink subframe.

In a fourth possible implementation manner of the third aspect, the determining, by a communication device, that a current subframe belongs to a first time segment includes determining, by the communication device, that the current subframe is the first subframe in the first time segment; and correspondingly, the determining, by the communication device, data transmission of the current subframe includes setting, by the communication device, a subframe number of the first subframe to a preset second subframe number, where the second subframe number is used to represent that the first subframe or a subframe 1 that meets a preset mapping relationship with the first subframe belongs to the first time segment; and determining, by the communication device, data transmission of the first subframe according to the second subframe number.

With reference to the fourth possible implementation manner of the third aspect, in a fifth possible implementation manner, before the determining, by the communication device, data transmission of the current subframe, the method further includes obtaining, by the communication device, a second uplink-downlink configuration; where the determining, by the communication device, data transmission of the current subframe includes determining, by the communication device, the data transmission of the first subframe according to the second subframe number and the second uplink-downlink configuration.

In a sixth possible implementation manner of the third aspect, before the determining, by the communication device, data transmission of the current subframe, the method further includes obtaining, by the communication device, a second uplink-downlink configuration; where the determining, by a communication device, that a current subframe belongs to a first time segment includes determining, by the communication device, that the current subframe is the first subframe in the first time segment; and correspondingly, the determining, by the communication device, data transmission of the current subframe includes determining, by the communication device, data transmission of the first subframe according to the second uplink-downlink configuration.

With reference to the first possible implementation manner of the third aspect, in a seventh possible implementation manner, the communication device is UE, and the mapping relationship is a feedback relationship, where the determining, by the communication device, that the current subframe belongs to the first time segment, and a subframe 1 that meets a preset mapping relationship with the current subframe belongs to a second time segment includes determining, by the UE according to the first time segment and the second time segment, that the first uplink subframe is an uplink subframe in the first time segment and the second downlink subframe is a downlink subframe in the second time segment; and correspondingly, the determining, by the communication device, data transmission of the current subframe includes sending, by the UE, uplink data to a base station in the first uplink subframe, and storing the uplink data in a transmission cache; and determining, by the UE, that the base station correctly receives the uplink data.

With reference to the seventh possible implementation manner of the third aspect, in an eighth possible implementation manner, after the UE sends the uplink data to the base station in the first uplink subframe and the UE determines that the base station does not correctly receive the uplink data, the method further includes determining, by the UE, a carrier indicator field CIF carried in scheduling information that is received in a third downlink subframe, where the CIF carries a process ID of the uplink data, the third downlink subframe is a downlink subframe that is after the second downlink subframe and in which a third uplink subframe is scheduled, and the third uplink subframe is an uplink subframe that is in the first time segment and after the first uplink subframe and whose subframe number is closest to a subframe number of the first uplink subframe; and determining, by the UE according to the process ID, to send the uplink data to the base station in the third uplink subframe.

With reference to the first possible implementation manner of the third aspect, in a ninth possible implementation manner, the communication device is a base station, the mapping relationship is a feedback relationship, and the determining, by the communication device, that the current subframe belongs to the first time segment, and a subframe 1 that meets a preset mapping relationship with the current subframe belongs to a second time segment includes determining, by the base station, that the current subframe is a first uplink subframe, the subframe 1 is a second downlink subframe in which feedback information corresponding to the first uplink subframe is located, where the second downlink subframe is a downlink subframe in the second time segment.

With reference to the ninth possible implementation manner of the third aspect, in a tenth possible implementation manner, the method further includes determining, by the base station after the base station correctly receives the uplink data in the first uplink subframe, to skip sending the feedback information to the UE in the second downlink subframe.

With reference to the ninth possible implementation manner of the third aspect, in an eleventh possible implementation manner, the method further includes determining, by the base station if the base station does not correctly receive the uplink data in the first uplink subframe, to send scheduling information in a third downlink subframe, where the scheduling information is used to schedule a third uplink subframe, the scheduling information carries a CIF, and the CIF carries a process ID of the uplink data.

With reference to any one of the foregoing third aspect, or the first to the sixth possible implementation manners of the third aspect, in a twelfth possible implementation manner, the communication device is UE or a base station.

The embodiments of the present invention provide a method and an apparatus for determining data transmission. If a communication device determines that a current subframe belongs to a first time segment, the communication device determines data transmission of the current subframe, where the first time segment is a time segment in which scheduling is allowed on a secondary component carrier, that is, a time segment in which a frequency resource is available. By determining that normal data transmission can be performed in all subframes in the time segment in which a frequency resource is available, the communication device ensures normal communication between a base station and UE, thereby improving communication efficiency between the base station and the UE.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a first schematic structural diagram of a subframe according to the prior art;

FIG. 2 is a first schematic structural diagram of a communication device according to an embodiment of the present invention;

FIG. 3 is a second schematic structural diagram of a communication device according to an embodiment of the present invention;

FIG. 4 is a third schematic structural diagram of a communication device according to an embodiment of the present invention;

FIG. 5 is a fourth schematic structural diagram of a communication device according to an embodiment of the present invention;

FIG. 6 is a fifth schematic structural diagram of a communication device according to an embodiment of the present invention;

FIG. 7 is a sixth schematic structural diagram of a communication device according to an embodiment of the present invention;

FIG. 8 is a first flowchart of a method for determining data transmission according to an embodiment of the present invention;

FIG. 9 is a second schematic structural diagram of a subframe according to an embodiment of the present invention;

FIG. 10 is a second flowchart of a method for determining data transmission according to an embodiment of the present invention;

FIG. 11 is a third flowchart of a method for determining data transmission according to an embodiment of the present invention;

FIG. 12 is a third schematic structural diagram of a subframe according to an embodiment of the present invention;

FIG. 13 is a fourth flowchart of a method for determining data transmission according to an embodiment of the present invention;

FIG. 14 is a fifth flowchart of a method for determining data transmission according to an embodiment of the present invention;

FIG. 15 is a sixth flowchart of a method for determining data transmission according to an embodiment of the present invention;

FIG. 16 is a fourth schematic structural diagram of a subframe according to an embodiment of the present invention; and

FIG. 17 is a seventh flowchart of a method for determining data transmission according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

Various technologies described in this specification may be applied to various wireless communications systems, for example, current 2G and 3G communications systems and a next-generation communications system, for example, a global system for mobile communications(GSM), a code division multiple access (CDMA) system, a time division multiple access (TDMA) system, wideband code division multiple access (WCDMA), a frequency division multiple access (FDMA) system, an orthogonal frequency-division multiple access (OFDMA) system, a single-carrier FDMA (SC-FDMA) system, a general packet radio service (GPRS) system, a long term evolution (LTE) system, and other communications systems.

UE may be a wireless terminal. The wireless terminal may refer to a device that provides a user with voice and/or data connectivity, a handheld device with a radio connection function, or another processing device connected to a radio modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, it may be a device such as a personal communication service (PCS) phone, a cordless telephone set, a Session Initiation Protocol (SIP) phone, a wireless local loop (WLL) station, or a personal digital assistant (PDA). The wireless terminal may also be called a system, a subscriber unit (subscriber unit), a subscriber station (subscriber station), a mobile station (mobile station), a mobile terminal (mobile), a remote station (remote station), an access point (access point), a remote terminal (remote terminal), an access terminal (access terminal), a user terminal (user terminal), a user agent (user agent), or user equipment (user device).

A base station may by an evolved Node B (eNB), a radio network controller (RNC), or a base station controller (BSC), namely, an access network device.

Specifically, a packet switched (PS) domain in a mobile communications system is used as an example. In 3G, the base station is the RNC. In 4G (4th Generation, the fourth generation of mobile communication technology), the base station is the eNB. In 2G (2rd Generation, the second generation of mobile communication technology), the base station is the BSC. A CS (Circuit Switch) domain in the mobile communications system is used as an example. In 3G/2G, the base station is the RNC (3G)/the BSC (2G).

An LTE-TDD system may support different uplink-downlink configurations (indicating a proportion of uplink subframes to downlink subframes in one TDD frame). Corresponding to the different uplink-downlink configurations, the base station may set a different timing relationship for scheduling scheduling information corresponding to uplink data, a different timing relationship for feeding back feedback information corresponding to the uplink data, and a different timing relationship for retransmitting the scheduling information corresponding to the uplink data. In different uplink-downlink configurations, the base station transmits, according to the set timing relationship of the scheduling information, the uplink data in an uplink subframe that meets the timing relationship of the scheduling information with a downlink subframe that is used to transmit the scheduling information; and transmits, according to the set timing relationship of the feedback information, the feedback information in a downlink subframe that meets the feedback timing relationship with an uplink subframe that is used to transmit the uplink data.

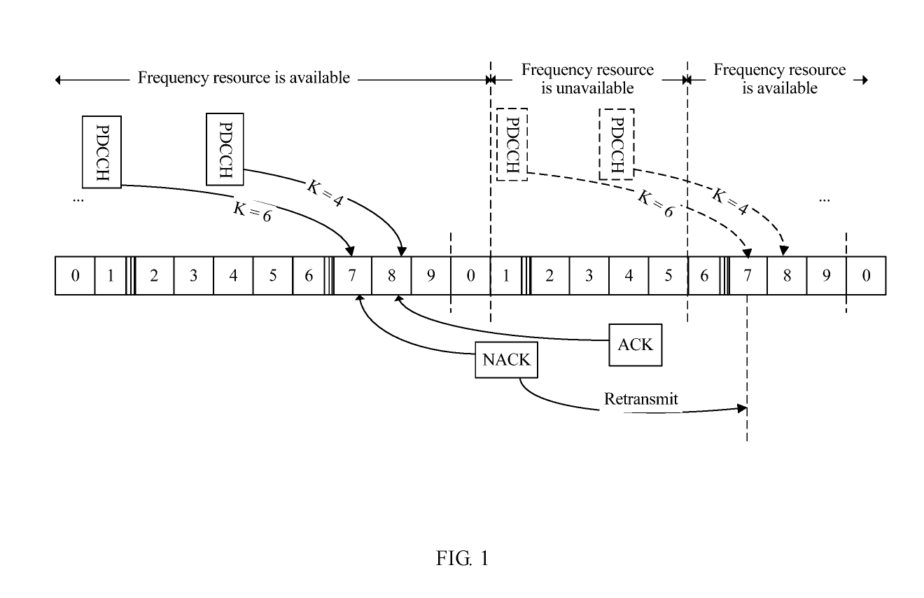

Exemplarily, as shown in FIG. 1, that an uplink-downlink configuration in a TDD frame supported by a carrier is downlink:uplink=3:2 is used as an example. A subframe numbered 2, a subframe numbered 3, a subframe numbered 7, and a subframe numbered 8 are uplink subframes; and a subframe numbered o, a subframe numbered 1, a subframe numbered 4, a subframe numbered 5, a subframe numbered 6, and a subframe numbered 9 are downlink subframes. According to the uplink-downlink configuration, a base station sends, to UE in the first subframe numbered 1, scheduling information for scheduling the first subframe numbered 7, and sends, to the UE in the first subframe numbered 4, scheduling information for scheduling the first subframe numbered 8. The UE separately sends, according to the scheduling information, uplink data to the base station in the first subframe numbered 7 and the first subframe numbered 8. The base station sends, to the UE, feedback information in the second subframe numbered 1 and feedback information in the second subframe numbered 4. The UE determines, according to the feedback information, whether to separately resend the uplink data to the base station in the second subframe numbered 7 and the second subframe numbered 8. In FIG. 1, it can be seen that, that the base station does not correctly receive the uplink data sent by the UE in the first subframe numbered 7 is fed back in the second subframe numbered 1, and the feedback information of the second subframe numbered 1 is NACK; that the base station correctly receives the uplink data sent by the UE in the first subframe numbered 8 is fed back in the second subframe numbered 4, and the feedback information of the second subframe numbered 4 is ACK.

It should be noted that, a K in FIG. 1 is a timing advance between two subframes that meet a mapping relationship. For example, when the mapping relationship is a scheduling relationship, a timing advance between the first subframe numbered 1 and the first subframe numbered 7 is K=6, that is, the subframe numbered 7 whose subframe number differs by 6 from a subframe number of the first subframe numbered 1 is scheduled in the first subframe numbered 1, that is 1+6=7. The base station sends, by using a PDCCH in the first subframe numbered 1, the scheduling information for scheduling the first subframe numbered 7.

### Embodiment 1

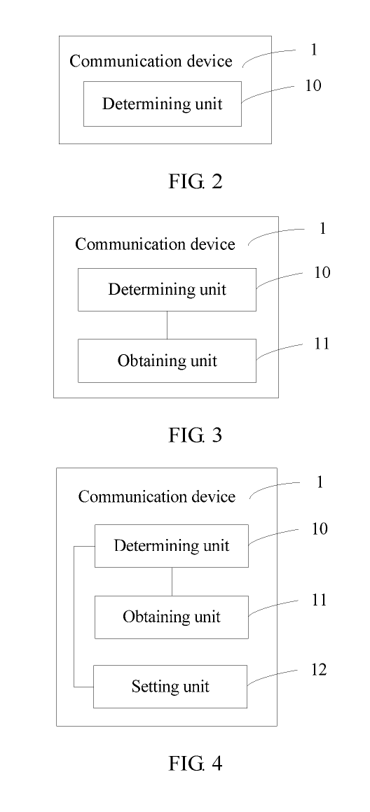

As shown in FIG. 2, this embodiment of the present invention provides a communication device 1, where the communication device 1 may include a determining unit 10, configured to: determine that a current subframe belongs to a first time segment, where the first time segment is a time segment in which scheduling is allowed on a secondary component carrier; and determine data transmission of the current subframe.

Optionally, the determining unit 10 is specifically configured to determine that the current subframe belongs to the first time segment, and a subframe 1 that meets a preset mapping relationship with the current subframe belongs to a second time segment, where the second time segment is a time segment in which scheduling is stopped on the secondary component carrier.

Optionally, as shown in FIG. 3, the communication device 1 further includes an obtaining unit 11.

The obtaining unit 11 is configured to obtain a first uplink-downlink configuration before the determining unit 10 determines that the current subframe belongs to the first time segment and the subframe 1 that meets the preset mapping relationship with the current subframe belongs to the second time segment.

Optionally, the mapping relationship is a scheduling relationship.

The determining unit 10 is specifically configured to: determine, according to the first uplink-downlink configuration obtained by the obtaining unit 11, that the current subframe is a first uplink subframe and the subframe 1 is a first downlink subframe that meets the scheduling relationship with the first uplink subframe; determine, according to the first time segment and the second time segment that are obtained by the obtaining unit 11, that the first uplink subframe is an uplink subframe in the first time segment and the first downlink subframe is a downlink subframe in the second time segment; and determine to transmit downlink data in the first uplink subframe.

Optionally, as shown in FIG. 4, the communication device 1 further includes a setting unit 12.

The determining unit 10 is specifically configured to determine that the current subframe is the first subframe in the first time segment.

The setting unit 12 is configured to set a subframe number of the first subframe determined by the determining unit 10 to a second subframe number, where the second subframe number is used to represent that the first subframe or a subframe 1 that meets a preset mapping relationship with the first subframe belongs to the first time segment.

The determining unit 10 is specifically configured to determine data transmission of the first subframe according to the second subframe number set by the setting unit 12.

Optionally, as shown in FIG. 3, the communication device 1 further includes an obtaining unit 11.

The obtaining unit 11 is configured to obtain a second uplink-downlink configuration before the determining unit 10 determines the data transmission of the current subframe.

The determining unit 10 is specifically configured to determine the data transmission of the first subframe according to the second subframe number set by the setting unit 12 and the second uplink-downlink configuration obtained by the obtaining unit 11.

Optionally, as shown in FIG. 3, the communication device 1 further includes an obtaining unit 11.

The obtaining unit 11 is configured to obtain a second uplink-downlink configuration before the determining unit 10 determines the data transmission of the current subframe.

The determining unit 10 is specifically configured to: determine that the current subframe is the first subframe in the first time segment, and determine data transmission of the first subframe according to the second uplink-downlink configuration obtained by the obtaining unit 11.

Optionally, the communication device is UE, and the mapping relationship is a feedback relationship.

The determining unit 10 is specifically configured to determine, according to the first time segment and the second time segment that are obtained by the obtaining unit 11, that the first uplink subframe is an uplink subframe in the first time segment and the second downlink subframe is a downlink subframe in the second time segment.

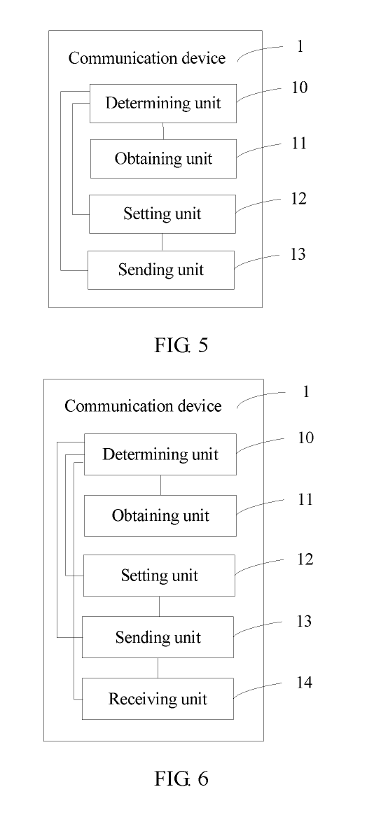

Correspondingly, as shown in FIG. 5, when the communication device 1 is UE, the communication device 1 further includes a sending unit 13.

The sending unit 13 is configured to: send uplink data to a base station in the first uplink subframe determined by the determining unit 10, and store the uplink data in a transmission cache.

The determining unit 10 is further configured to determine that the base station correctly receives the uplink data sent by the sending unit 13.

Optionally, the determining unit 10 is further configured to: after determining that the base station does not correctly receive the uplink data sent by the sending unit 13, determine a CIF carried in scheduling information that is received in a third downlink subframe, where the CIF carries a process ID of the uplink data; and determine, according to the process ID, that the sending unit 13 sends the uplink data to the base station in a third uplink subframe, where the third downlink subframe is a downlink subframe that is after the second downlink subframe and in which the third uplink subframe is scheduled, and the third uplink subframe is an uplink subframe that is in the first time segment and after the first uplink subframe and whose subframe number is closest to a subframe number of the first uplink subframe.

Optionally, the communication device 1 is a base station, and the mapping relationship is a feedback relationship.

The determining unit 10 is specifically configured to determine that the current subframe is a first uplink subframe, the subframe 1 is a second downlink subframe in which feedback information corresponding to the first uplink subframe is located, and the second downlink subframe is a downlink subframe in the second time segment.

Optionally, as shown in FIG. 6, when the communication device 1 is a base station, the communication device 1 further includes a receiving unit 14.

The determining unit 10 is further configured to: after the receiving unit 14 correctly receives the uplink data in the first uplink subframe, determine to skip sending the feedback information to the UE in the second downlink subframe.

Optionally, the determining unit 10 is further configured to: if the receiving unit 14 does not correctly receive the uplink data in the first uplink subframe, determine that the sending unit 13 sends scheduling information in a third downlink subframe, where the scheduling information is used to schedule a third uplink subframe, the scheduling information carries a CIF, and the CIF carries a process ID of the uplink data.

Optionally, the communication device 1 is UE or a base station.

This embodiment of the present invention provides a communication device. If the communication device determines that a current subframe belongs to a first time segment, the communication device determines data transmission of the current subframe, where the first time segment is a time segment in which scheduling is allowed on a secondary component carrier, that is, a time segment in which a frequency resource is available. By determining that normal data transmission can be performed in all subframes in the time segment in which a frequency resource is available, the communication device ensures normal communication between a base station and UE, thereby improving communication efficiency between the base station and the UE.

### Embodiment 2

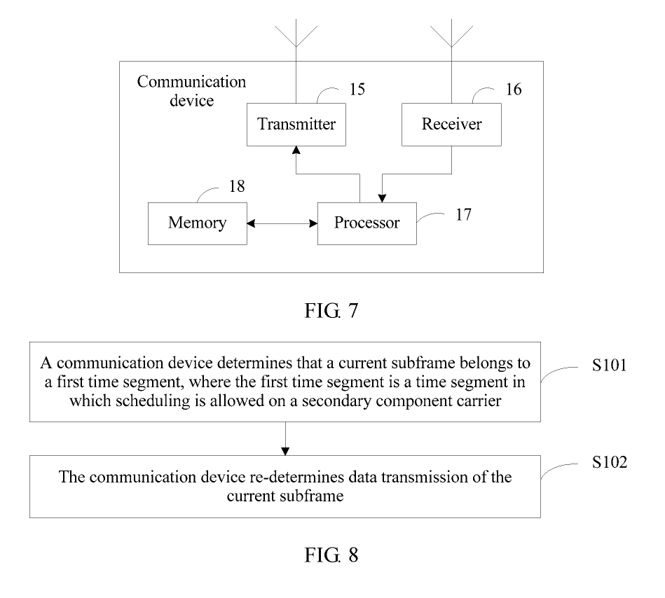

As shown in FIG. 7, this embodiment of the present invention provides a communication device, including: a transmitter 15, a receiver 16, a processor 17, and a memory 18. All of the transmitter 15, the receiver 16, and the memory 18 are connected to the processor 17, for example, all of the transmitter 15, the receiver 16, and the memory 18 may be connected to the processor 17 by using a bus.

The receiver 16 and the transmitter 15 may be integrated to form a transceiver.

The memory 18 is configured to store executable program code, where the program code includes a computer operation instruction. The memory 18 may include a high-speed RAM memory, and may further include a non-volatile memory, such as at least one magnetic disk memory.

The processor 17 may be a central processing unit or an application-specific integrated circuit, or is configured as one or more integrated circuits that implement the embodiment of the present invention.

Specifically, the processor 17 may be configured to determine that a current subframe belongs to a first time segment, where the first time segment is a time segment in which scheduling is allowed on a secondary component carrier, and determine data transmission of the current subframe; the transmitter 15 may be configured to send data; the receiver 16 may be configured to receive the data; and the memory 18 may be configured to store software code of information about the time segment in which scheduling is allowed on the secondary component carrier and a software program that controls the communication device to complete the foregoing process, so that the processor 17 completes the foregoing process by executing the foregoing software program and invoking the foregoing software code.

Optionally, the processor 17 is specifically configured to determine that the current subframe belongs to the first time segment, and a subframe 1 that meets a preset mapping relationship with the current subframe belongs to a second time segment, where the second time segment is a time segment in which scheduling is stopped on the secondary component carrier.

Optionally, the processor 17 is further configured to obtain a preset first uplink-downlink configuration before determining that the current subframe belongs to the first time segment and the subframe 1 that meets the preset mapping relationship with the current subframe belongs to the second time segment.

Optionally, the mapping relationship is a scheduling relationship.

The processor 17 is specifically configured to: determine, according to the first uplink-downlink configuration, that the current subframe is a first uplink subframe and the subframe 1 is a first downlink subframe that meets the scheduling relationship with the first uplink subframe; determine, according to the first time segment and the second time segment, that the first uplink subframe is an uplink subframe in the first time segment and the first downlink subframe is a downlink subframe in the second time segment; and determine to transmit downlink data in the first uplink subframe.

Optionally, the processor 17 is specifically configured to: determine that the current subframe is the first subframe in the first time segment; set a subframe number of the first subframe to a preset second subframe number, where the second subframe number is used to represent that the first subframe or a subframe 1 that meets a preset mapping relationship with the first subframe belongs to the first time segment; and determine data transmission of the first subframe according to the second subframe number.

Optionally, the processor 17 is further configured to obtain a second uplink-downlink configuration before determining the data transmission of the current subframe.

The processor 17 is specifically configured to determine the data transmission of the first subframe according to the second subframe number and the second uplink-downlink configuration.

Optionally, the processor 17 is further configured to: before determining the data transmission of the current subframe, obtain a second uplink-downlink configuration, determine that the current subframe is the first subframe in the first time segment, and determine data transmission of the first subframe according to the second uplink-downlink configuration.

Optionally, the communication device is the UE, and the mapping relationship is a feedback relationship.

The processor 17 is specifically configured to determine, according to the first time segment and the second time segment, that the first uplink subframe is an uplink subframe in the first time segment and the second downlink subframe is a downlink subframe in the second time segment.

Correspondingly, when the communication device is the UE, the transmitter 15 is further configured to: send uplink data to a base station in the first uplink subframe determined by the processor 17, and store the uplink data in a transmission cache.

The processor 17 is further configured to determine that the base station correctly receives the uplink data sent by the transmitter 15.

Optionally, the communication device is UE.

The processor 17 is further configured to: after determining that the base station does not correctly receive the uplink data, determine a carrier indicator field CIF carried in scheduling information that is received in a third downlink subframe, where the CIF carries a process ID of the uplink data; and determine, according to the process ID, that the transmitter 15 sends the uplink data to the base station in the first uplink subframe, where the third downlink subframe is a downlink subframe that is after the second downlink subframe and in which the third uplink subframe is scheduled, and the third uplink subframe is an uplink subframe that is in the first time segment and after the first uplink subframe and whose subframe number is closest to a subframe number of the first uplink subframe.

Optionally, the communication device is a base station, and the mapping relationship is a feedback relationship.

The processor 17 is specifically configured to determine that the current subframe is a first uplink subframe, the subframe 1 is a second downlink subframe in which feedback information corresponding to the first uplink subframe is located, and the second downlink subframe is a downlink subframe in the second time segment.

Optionally, when the communication device is a base station, the processor 17 is further configured to: after the receiver 16 correctly receives the uplink data in the first uplink subframe, determine to skip sending the feedback information to the UE in the second downlink subframe.

Optionally, the processor 17 is further configured to: if the receiver 16 does not correctly receive the uplink data in the first uplink subframe, determine that the transmitter 15 sends scheduling information in a third downlink subframe, where the scheduling information is used to schedule a third uplink subframe, the scheduling information carries a CIF, and the CIF carries a process ID of the uplink data.

Optionally, the communication device is UE or a base station.

This embodiment of the present invention provides a communication device. If the communication device determines that a current subframe belongs to a first time segment, the communication device determines data transmission of the current subframe, where the first time segment is a time segment in which scheduling is allowed on a secondary component carrier, that is, a time segment in which a frequency resource is available. By determining that normal data transmission can be performed in all subframes in the time segment in which a frequency resource is available, the communication device ensures normal communication between a base station and UE, thereby improving communication efficiency between the base station and the UE.

### Embodiment 3

This embodiment of the present invention provides a method for determining data transmission. As shown in FIG. 8, the method may include the following steps.

S101. A communication device determines that a current subframe belongs to a first time segment, where the first time segment is a time segment in which scheduling is allowed on a secondary component carrier.

A Long Term Evolution Advanced (LTE-A) system is a further evolved and enhanced system of a 3rd Generation Partnership Project (3GPP) LTE system. In the LTE-A system, a carrier aggregation (CA) technology is introduced to meet a requirement of the International Telecommunication Union in a peak data rate of the fourth generation communication technology. In the CA technology, frequency spectrums of two or more component carriers (Component Carrier) are aggregated to obtain higher transmission bandwidth. The frequency spectrum of the component carriers may be consecutive frequency spectrums adjacent to each other, or may be frequency spectrums not adjacent to each other in a same band, or may even be inconsecutive frequency spectrums in different bands. LTE-A user equipment may simultaneously access, according to a capability of the user equipment and a service requirement, multiple component carriers to transmit and receive data.

In an existing CA system, carriers in a same base station are aggregated, or carriers in a macro cell and a micro cell that have ideal backhaul are aggregated. For example, a macro cell and a micro cell are connected by using an optical fiber (the micro cell may also be a wireless radio-frequency head). In this way, a base station can obtain all information carried in multiple component carriers in time, and the base station can perform joint scheduling on the multiple component carriers.

It should be noted that, the method for determining data transmission provided in this embodiment of the present invention is a process of performing data transmission between a base station and UE in a secondary component carrier. The method may be applied to a process of performing data transmission in any secondary component carrier, which is not limited in the present invention.

In this embodiment of the present invention, a base station may configure one primary component carrier and at least one secondary component carrier for UE, and perform data transmission by using the primary component carrier and the at least one secondary component carrier. In this embodiment of the present invention, an LTE carrier is deployed in an unlicensed spectrum, and the LTE carrier is used as a secondary component carrier in the method for determining data transmission provided in the present invention. The unlicensed spectrum refers to a public spectrum that is not a dedicated carrier in which a base station can perform data transmission. Therefore, in the present invention, frequency resources used by the base station and the UE to perform data transmission in the secondary component carrier may be inconsecutive. When different base stations transmit data by using one secondary component carrier, these base stations need to contend with each other to obtain a time segment in which the base stations can transmit the data in the secondary component carrier.

It should be noted that, in a time division duplex long term evolution (TDD-LTE) system, one frame includes 10 subframes. In the 10 subframes, some subframes are uplink subframes, some subframes are downlink subframes, or there may be a special subframe, where the special subframe includes both an uplink channel and a downlink channel. In an FDD-LTE (Frequency Division Duplexing Long Term Evolution, frequency-division duplex long term evolution) system, one uplink radio frame includes 10 uplink subframes, and one downlink radio frame includes 10 downlink subframes. In the FDD-LTE system, uplink and downlink are separated and use different frequencies. The base station sends a downlink channel in a downlink subframe or the special subframe so as to transmit data to the UE, and the UE sends an uplink channel in an uplink subframe or the special subframe so as to transmit data to the base station.

In a practical application, in the TDD-LTE system, it is assumed that subframe numbers of 10 subframes in a TDD frame are j, and a value of j is an integer from 0 to 9. When j+1 is greater than 9, a subframe j+1 is numbered (j+1) mod 10; and when j−1 is less than 0, a subframe j−1 is numbered (j−1) mod 10.

It may be understood that, in the TDD-LTE system, subframes in each frame are numbered 0-9, that is, subframe numbers of each frame are 0-9.

Specifically, in the TDD-LTE system, according to different configurations between uplink and downlink, there may be seven uplink-downlink configurations. One subframe has one millisecond, and one frame has 10 milliseconds. If five milliseconds is a period, there are three uplink-downlink configurations, that is, downlink:uplink=2:3, downlink:uplink=3:2, and downlink:uplink=4:1. If 10 milliseconds is a period, there are four uplink-downlink configurations, that is, downlink:uplink=5:5, downlink:uplink=7:3, downlink:uplink=8:2, and downlink:uplink=9:1.

It should be noted that, before determining that the current subframe belongs to the first time segment, where the first time segment is the time segment in which scheduling is allowed on the secondary component carrier, the communication device determines information about the time segment in which scheduling is allowed on the secondary component carrier, where the secondary component carrier is a secondary component carrier used when the communication device performs communication, and the information about the time segment in which scheduling is allowed on the secondary component carrier includes the first time segment in which scheduling is allowed on the secondary component carrier.

The method for determining data transmission provided in this embodiment of the present invention is mainly applied to the TDD-LTE system. The communication device determines the information about the time segment in which scheduling is allowed on the secondary component carrier, where the secondary component carrier is the secondary component carrier used when the communication device performs communication, and the information about the time segment in which scheduling is allowed on the secondary component carrier includes the first time segment in which scheduling is allowed on the secondary component carrier.

Optionally, the communication device in this embodiment of the present invention may be UE or a base station. When the communication device is UE, a base station notifies the UE of at least one of start and end time points at which scheduling is allowed on the secondary component carrier or start and end time points at which scheduling is stopped on the secondary component carrier. The UE may determine, according to the at least one of the start and end time points at which scheduling is allowed on the secondary component carrier or the start and end time points at which scheduling is stopped on the secondary component carrier, the information about the time segment in which scheduling is allowed on the secondary component carrier. The information about the time segment in which scheduling is allowed on the secondary component carrier includes the first time segment in which scheduling is allowed on the secondary component carrier. When the communication device is a base station, the base station may determine by itself the information about the time segment in which scheduling is allowed on the secondary component carrier.

It should be noted that, a method in which the base station notifies the UE of the at least one of the start and end time points at which scheduling is allowed on the secondary component carrier or the start and end time points at which scheduling is stopped on the secondary component carrier may be: the base station sends a notification message to the UE by using the primary component carrier or another secondary component carrier. A sending manner of the notification message is notifying by using a PDCCH or a Media Access Control MAC (Media Access Control, Media Access Control) layer.

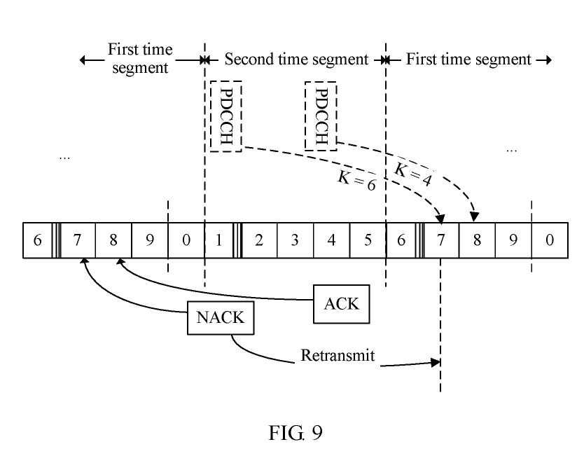

Exemplarily, the base station may send the notification message to the UE by using the PDCCH, and the notification message carries the start and end time points at which scheduling is stopped on the secondary component carrier. As shown in FIG. 9, in a time segment in which no frequency resource is available, a subframe numbered 1 is a start time point at which scheduling is stopped on the secondary component carrier and a subframe numbered 5 is an end time point at which scheduling is stopped on the secondary component carrier. A time segment from the subframe numbered 1 to the subframe numbered 5 is a second time segment. The second time segment is a time segment in which scheduling cannot be performed. In a time segment that is in a frequency spectrum in which the secondary component carrier is located, a time segment except the second time segment is the first time segment, that is, a time segment except the time segment in which no frequency resource is available is a time segment in which a frequency resource is available.

Specifically, after determining the first time segment in which scheduling is allowed on the secondary component carrier, the communication device may determine that the current subframe belongs to the first time segment.

It may be understood that, the first time segment is the time segment in which a frequency resource is available, and the communication device can perform data transmission only in the time segment in which a frequency resource is available.

Exemplarily, as shown in FIG. 1, the first time segment is the time segment in which a frequency resource is available.

S102. The communication device determines data transmission of the current subframe.

After determining that the current subframe belongs to the first time segment, the communication device determines the data transmission of the current subframe.

It should be noted that, generally, uplink data may be transmitted in an uplink subframe, and downlink data may be transmitted in a downlink subframe.

It may be understood that, in the method for determining data transmission provided in this embodiment of the present invention, the communication device determines that normal data transmission can be performed in each current subframe that belongs to the first time segment, so that a frequency resource may be fully used to perform data transmission in a subframe that belongs to the first time segment. Specifically, a later part of this embodiment describes in detail a method in which the communication device determines the data transmission of the current subframe.

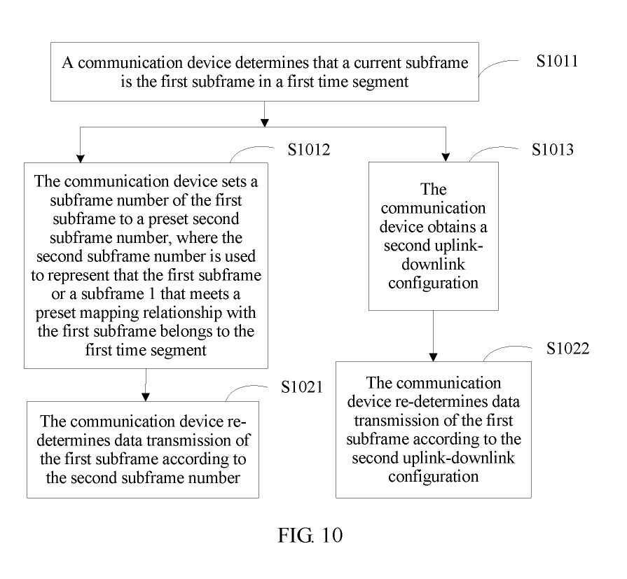

Specifically, as shown in FIG. 10, S101 specifically includes S1011-S1013, and S102 specifically includes S1021-S1022, which are as follows.

S1011. The communication device determines that the current subframe is the first subframe in the first time segment.

The communication device determines that the current subframe is the first subframe in the first time segment.

Specifically, according to the information about the time segment in which scheduling is allowed on the secondary component carrier, the communication device determines that the current subframe is the first subframe in the first time segment.

Exemplarily, if the first time segment is the time segment from the subframe numbered 1 to the subframe numbered 5, the subframe numbered 1 is the first subframe in the first time segment.

S1012. The communication device sets a subframe number of the first subframe to a preset second subframe number, where the second subframe number is used to represent that the first subframe or a subframe 1 that meets a preset mapping relationship with the first subframe belongs to the first time segment.

After determining that the current subframe is the first subframe in the first time segment, the communication device sets the subframe number of the first subframe to the preset second subframe number. The second subframe number is used to represent that the first subframe or the subframe 1 that meets the preset mapping relationship with the first subframe belongs to the first time segment.

It should be noted that, the second subframe number in this embodiment of the present invention may be a subframe number pre-defined in the communication device, or may be a subframe number obtained by the communication device when a subframe number is set. A specific setting manner is not limited in the present invention.

For example, after determining that the current subframe is a subframe numbered 8, that is, after determining that the current subframe is the first subframe in the first time segment, the communication device sets a subframe number of the current subframe to a subframe numbered 2.

It may be understood that, the second subframe number is set in order that each subframe from the first subframe in the first time segment can be used, so that a frequency resource is properly used. Therefore, the second subframe number is used to represent that the first subframe or the subframe 1 that meets the preset mapping relationship with the first subframe belongs to the first time segment. After the subframe number of the first subframe in the first time segment is set to the second subframe number, a subframe number of a subframe after the first subframe is accordingly changed, which is implemented by subframe numbering software.

S1013. The communication device obtains a second uplink-downlink configuration.

The communication device obtains the second uplink-downlink configuration after determining that the current subframe is the first subframe in the first time segment.

Optionally, the second uplink-downlink configuration in this embodiment of the present invention may be an uplink-downlink configuration pre-defined in the communication device, or may be an uplink-downlink configuration obtained by the communication device. A specific setting manner is not limited in the present invention.

Further, when the communication device is the base station, the base station learns the preset or pre-configured second uplink-downlink configuration. When the communication device is the UE, the base station sends the notification message to the UE so as to notify the UE of the second uplink-downlink configuration. The sending manner of the notification message is notifying by using the PDCCH or the Media Access Control MAC layer.

It should be noted that, S1012 and S1013 are two optional steps after S1011, that is, after S1011, S1012 may be executed, or S1013 may be executed.

S1021. The communication device determines data transmission of the first subframe according to the second subframe number.

After setting the subframe number of the first subframe to the second subframe number, the communication device determines the data transmission of the first subframe according to the second subframe number.

It should be noted that, the second subframe number is used to identify information about the data transmission of the current subframe. The second subframe number is preset. The information about the data transmission is used to represent a direction of the data transmission. The communication device may determine the data transmission of the current subframe according to the information about the data transmission identified by the second subframe number.

Exemplarily, if the second subframe number of the first subframe in the first time segment is 0, and a subframe numbered 0 is a downlink subframe, the communication device determines to transmit downlink data in the first subframe.

S1022. The communication device determines data transmission of the first subframe according to the second uplink-downlink configuration.

After obtaining the second uplink-downlink configuration, the communication device determines the data transmission of the first subframe according to the second uplink-downlink configuration.

It should be noted that, a subframe number and a type of data transmitted in a subframe can be learned according to the second uplink-downlink configuration. Therefore, the communication device may determine the data transmission of the current subframe according to a new second uplink-downlink configuration.

It should be noted that, S1021 is a step after S1012, and S1022 is a step after S1013.

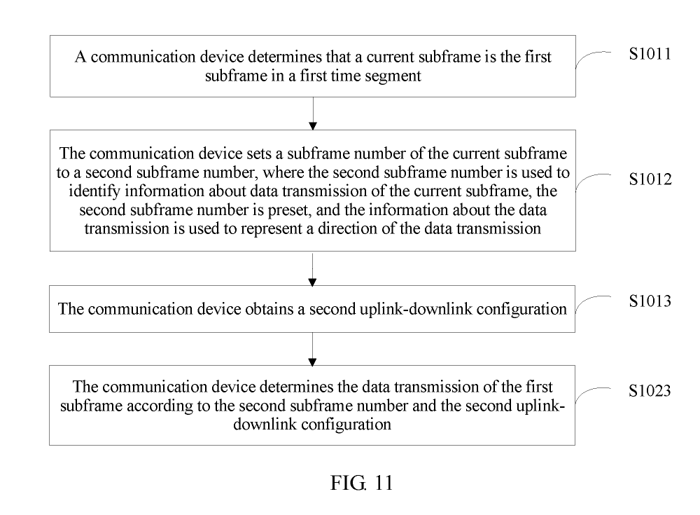

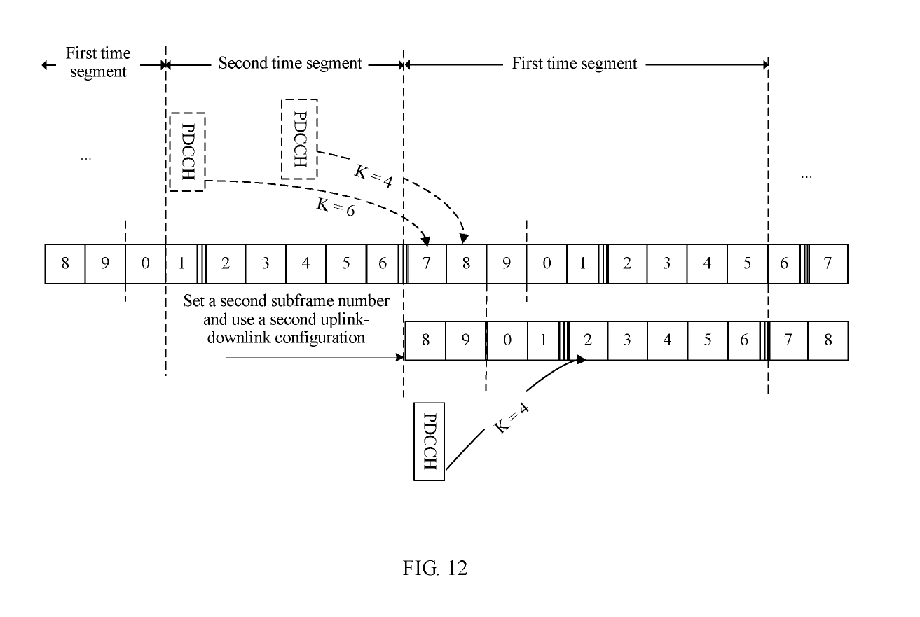

Further, as shown in FIG. 11, an execution order between S1012 and S1013 is not limited in this embodiment of the present invention. That is, in this embodiment of the present invention, S1012 may be executed before S1013, S1013 may be executed before S1012, or S1012 and S1013 may be executed simultaneously.

Optionally, as shown in FIG. 11, S1021 and S1022 may be specifically S1023.

S1023. The communication device determines the data transmission of the first subframe according to the second subframe number and the second uplink-downlink configuration.

The communication device sets the subframe number of the current subframe to the second subframe number, and after obtaining the second uplink-downlink configuration, the communication device determines the data transmission of the first subframe according to the second subframe number and the second uplink-downlink configuration.

It may be understood that, there are seven uplink-downlink configurations in the TDD-LTE system. When different configuration relationships are used in a process in which the communication device transmits data, the communication device may not be able to perform data transmission in the current subframe only by changing the subframe number of the current subframe or changing a current uplink-downlink configuration. In this case, the communication device may change both the subframe number of the current subframe and the current uplink-downlink configuration, so that data transmission can definitely be performed in the current subframe, thereby achieving proper use of a frequency resource.

For example, as shown in FIG. 12, in the first time segment in which a frequency resource is available, that an uplink-downlink configuration supported by a current secondary component carrier is downlink:uplink=3:2 is used as an example. It is assumed that the communication device determines that the current subframe is the first subframe in the first time segment, that is, the first subframe numbered 7. The first subframe numbered 7 is an uplink subframe. A subframe numbered 4 in which the first subframe numbered 7 is scheduled is in the second time segment in which no frequency resource is available, and therefore uplink data transmission cannot be performed in the first subframe numbered 7. The communication device sets a subframe number of the first subframe numbered 7 to 8 and sets the current uplink-downlink configuration to 4:1, so that the communication device can schedule a subframe numbered 2 in the subframe numbered 8, that is, the communication device determines to transmit downlink data in the current subframe: the subframe numbered 8.

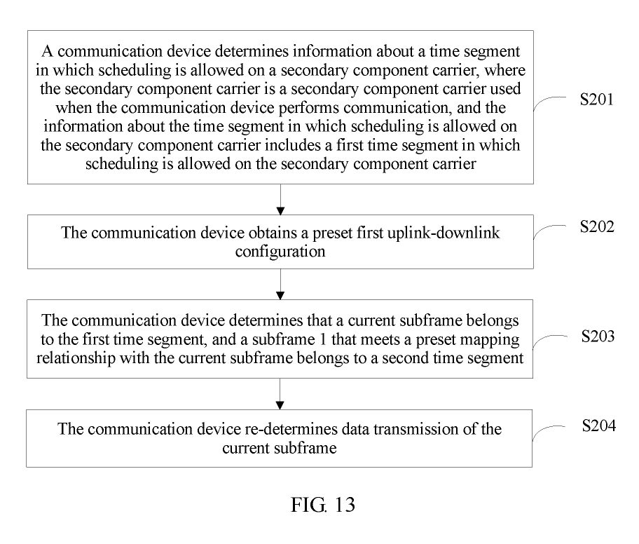

Further, as shown in FIG. 13, this embodiment of the present invention further provides a method for determining data transmission, and the method includes S201-S204.

S201. A communication device determines information about a time segment in which scheduling is allowed on a secondary component carrier, where the secondary component carrier is a secondary component carrier used when the communication device performs communication, and the information about the time segment in which scheduling is allowed on the secondary component carrier includes a first time segment in which scheduling is allowed on the secondary component carrier.

Specifically, for a process in which the communication device determines the information about the time segment in which scheduling is allowed on the secondary component carrier and related description, reference may be made to the related description of S101 in this embodiment of the present invention. Details are not described herein again.

S202. The communication device obtains a preset first uplink-downlink configuration.

In a process in which the communication device performs data transmission, the communication device determines data transmission of each subframe according to the preset first uplink-downlink configuration.

Specifically, when the communication device is a base station, the first uplink-downlink configuration is learned by the base station; when the communication device is UE, the first uplink-downlink configuration is notified to the UE by a base station.

It may be understood that, the first uplink-downlink configuration in this embodiment of the present invention is a preset uplink-downlink configuration used when communication is performed between the base station and the UE.

It should be noted that, an execution order between S201 and S202 is not limited in this embodiment of the present invention. That is, S201 may be executed before S202, or S202 may be executed before S201.

S203. The communication device determines that a current subframe belongs to the first time segment, and a subframe 1 that meets a preset mapping relationship with the current subframe belongs to a second time segment.

After determining the information about the time segment in which scheduling is allowed on the secondary component carrier, the communication device determines that the current subframe belongs to the first time segment, and the subframe 1 that meets the preset mapping relationship with the current subframe belongs to the second time segment.

Optionally, the preset mapping relationship in this embodiment of the present invention may be a scheduling relationship or a feedback relationship.

It should be noted that, some time is needed to transmit a wireless signal from the base station to the UE, the UE further needs some time to prepare for uplink data transmission, and sending of the uplink data transmission needs to be earlier than expected receiving by the base station. Therefore, in 3GPP LTE, information about scheduling for transmission of the coming uplink data needs to be sent at the latest in a subframe that is four subframes before an expected subframe in which the transmission arrives at the base station. That is, when the communication device transmits the uplink data in an uplink subframe, the communication device can transmit the uplink data in the uplink subframe only after the communication device sends the scheduling information in advance in a downlink subframe in which the uplink subframe is scheduled.

For example, the base station needs to transmit the uplink data in an uplink subframe numbered 7, and the corresponding scheduling information is sent from the base station in a downlink subframe numbered 3. If a subframe numbered 3 is an uplink subframe, the corresponding scheduling information needs to be sent in advance. In a downlink subframe, the base station needs to notify downlink data transmission in the same downlink subframe and the uplink data transmission performed in the uplink subframe. That is, there are at least one to three OFDM symbols between the current subframe and the subframe 1 (in some limited cases, there may be four orthogonal frequency division multiplexing (OFDM) symbols). In a case of a normal cyclic prefix, each downlink subframe includes 14 OFDM symbols, and actual data transmission may be performed in 10 to 13 OFDM symbols of the 14 OFDM symbols.

S204. The communication device determines data transmission of the current subframe.

Specifically, for a process in which the communication device determines the data transmission of the current subframe and related description, reference may be made to the steps and description of S102 in this embodiment of the present invention. Details are not described herein again.

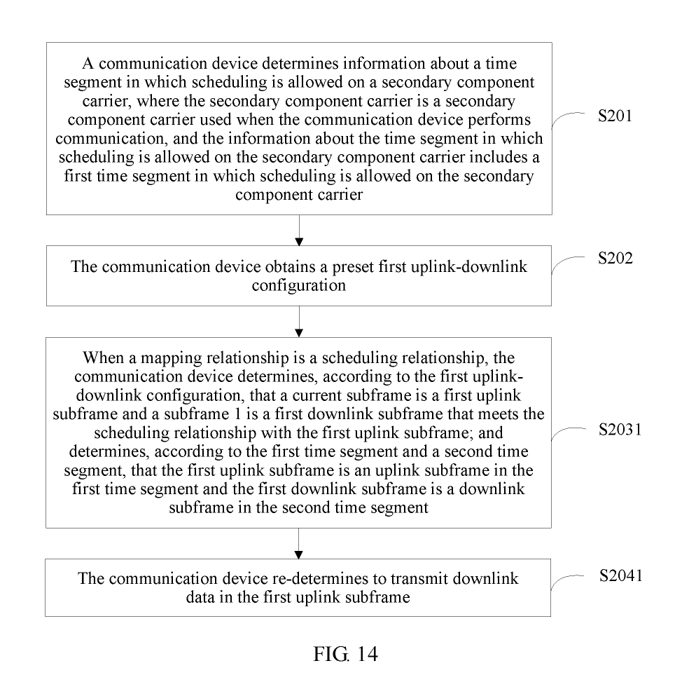

Specifically, as shown in FIG. 14, S203 specifically includes S2031, and S204 specifically includes S2041, which are as follows.

S2031. When the mapping relationship is a scheduling relationship, the communication device determines, according to the first uplink-downlink configuration, that the current subframe is a first uplink subframe and the subframe 1 is a first downlink subframe that meets the scheduling relationship with the first uplink subframe; and determines, according to the first time segment and the second time segment, that the first uplink subframe is an uplink subframe in the first time segment and the first downlink subframe is a downlink subframe in the second time segment.

When the mapping relationship is the scheduling relationship, after obtaining the first uplink-downlink configuration, the communication device determines, according to the first uplink-downlink configuration, that the current subframe is the first uplink subframe and the subframe 1 is the first downlink subframe that meets the scheduling relationship with the first uplink subframe; and determines, according to the first time segment and the second time segment, that the first uplink subframe is an uplink subframe in the first time segment and the first downlink subframe is a downlink subframe in the second time segment.

Exemplarily, as shown in FIG. 12, that a first uplink-downlink configuration supported by a current secondary component carrier is downlink:uplink=3:2 is used as an example. It is assumed that the first subframe numbered 7 is the current subframe, and the communication device is a base station. The base station determines, according to the first uplink-downlink configuration and the first time segment, that the first subframe numbered 7 is the first uplink subframe in the first time segment, and the base station determines, according to the first uplink-downlink configuration, that the first downlink subframe in which the first subframe numbered 7 is scheduled is a subframe numbered 1 before the first subframe numbered 7. The base station determines, according to the second time segment, that the subframe numbered 1 belongs to the second time segment.

It should be noted that, S2041 is executed after S2031.

S2041. The communication device determines to transmit downlink data in the first uplink subframe.

When the mapping relationship is the scheduling relationship, the communication device determines to transmit the downlink data in the first uplink subframe, after the communication device determines, according to the first uplink-downlink configuration, that the current subframe is the first uplink subframe and the subframe 1 is the first downlink subframe that meets the scheduling relationship with the first uplink subframe, and determines, according to the first time segment and the second time segment, that the first uplink subframe is an uplink subframe in the first time segment and the first downlink subframe is a downlink subframe in the second time segment.

It may be understood that, the first downlink subframe in which the first uplink subframe is scheduled belongs to the second time segment, and the second time segment is a time segment in which no frequency resource is available, and therefore the communication device cannot schedule the first uplink subframe in the first downlink subframe. As a result, the uplink data cannot be transmitted in the first uplink subframe. Therefore, in the method for determining data transmission proposed in this embodiment of the present invention, transmitting the downlink data in the first uplink subframe in the foregoing case is determined, so that a waste of a frequency resource in the first uplink subframe is avoided.

It should be noted that, the communication device in the foregoing embodiment may be a base station or UE.

It may be understood that, the base station interacts with the UE in a process of performing data transmission between the base station and the UE. Therefore, if the base station intends to send downlink data to the UE in a subframe, the UE needs to learn that the downlink data sent by the base station needs to be received in the subframe. Likewise, if the UE intends to send uplink data to the base station in a subframe, the base station needs to learn that the uplink data sent by the UE needs to be received in the subframe.

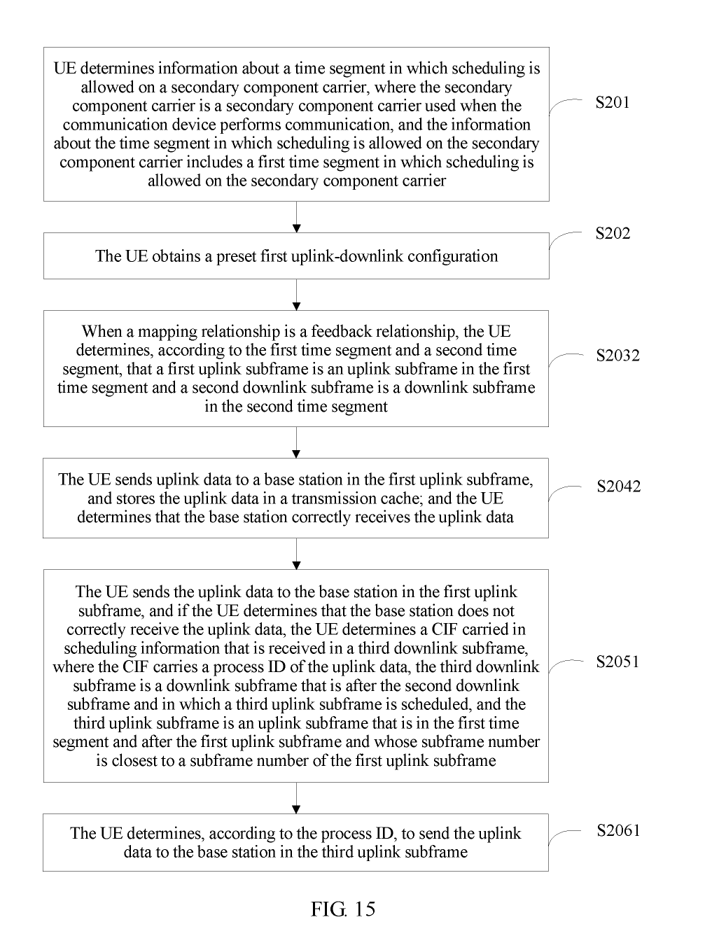

Further, as shown in FIG. 15, when the communication device is UE, the foregoing S203 specifically includes S2032, S204 specifically includes S2042, and after S2042, the method for determining data transmission provided in this embodiment of the present invention further includes S2051-S2061, which are specifically as follows.

S2032. When the mapping relationship is a feedback relationship, the UE determines, according to the first time segment and the second time segment, that a first uplink subframe is an uplink subframe in the first time segment and the second downlink subframe is a downlink subframe in the second time segment.

When the mapping relationship is the feedback relationship, after the communication device determines the information about the time segment in which scheduling is allowed on the secondary component carrier, the UE determines, according to the first uplink-downlink configuration, that the current subframe is the first uplink subframe and the subframe 1 is the second downlink subframe that meets the feedback relationship with the first uplink subframe; and determines, according to the first time segment and the second time segment, that the first uplink subframe is an uplink subframe in the first time segment and the second downlink subframe is a downlink subframe in the second time segment.

It should be noted that, in the process in which the communication device transmits data, after transmitting the uplink data in the first uplink subframe, the communication device needs to receive, in the second downlink subframe after the first uplink subframe, feedback information about whether the uplink data is normally transmitted, where the second downlink subframe is a subframe that meets the feedback relationship with the first uplink subframe.

Exemplarily, as shown in FIG. 9, that the first uplink-downlink configuration supported by the current secondary component carrier is downlink:uplink=3:2 is used as an example. It is assumed that the first subframe numbered 7 is the current subframe, and the communication device is a base station. The base station determines, according to the first uplink-downlink configuration and the first time segment, that the first subframe numbered 7 is the first uplink subframe in the first time segment, and the base station determines, according to the first uplink-downlink configuration, that the second downlink subframe in which the first subframe numbered 7 is fed back is the first subframe numbered 1 after the first subframe numbered 7. The base station determines, according to the second time segment, that the first subframe numbered 1 belongs to the second time segment.

It should be noted that, S2042 is executed after S2032.

S2042. The UE sends uplink data to a base station in the first uplink subframe, and stores the uplink data in a transmission cache; and the UE determines that the base station correctly receives the uplink data.

When the mapping relationship is the feedback relationship, after the UE determines, according to the first time segment and the second time segment, that the first uplink subframe is an uplink subframe in the first time segment and the second downlink subframe is a downlink subframe in the second time segment, the UE sends the uplink data to the base station in the first uplink subframe, and stores the uplink data in the transmission cache; and the UE determines that the base station correctly receives the uplink data.

It should be noted that, the communication device determines that the current subframe is the first uplink subframe that belongs to the first time segment, and therefore the UE may send the uplink data to the base station in the first uplink subframe. In this embodiment of the present invention, the UE stores the uplink data in the transmission cache, so that the UE may resend the uplink data stored in the transmission cache to the base station when the base station does not correctly receive the uplink data.

It may be understood that, when the current subframe in which the feedback information is fed back, that is, the second downlink subframe for the first uplink subframe belongs to the second time segment in which no frequency resource is available, the UE stores the uplink data in the transmission cache after transmitting the uplink data to the base station; and the UE determines that the base station correctly receives the uplink data, so that when the UE cannot receive the feedback information sent by the base station by using the second downlink subframe, the UE determines that the uplink data is correctly received by the base station. In this way, the UE does not need to keep waiting for the foregoing feedback information, but performs data transmission of another process, so that a frequency resource is fully used.

S2051. The UE sends the uplink data to the base station in the first uplink subframe, and if the UE determines that the base station does not correctly receive the uplink data, the UE determines a CIF (carrier indicator field) carried in scheduling information that is received in a third downlink subframe, where the CIF carries a process ID of the uplink data, the third downlink subframe is a downlink subframe that is after the second downlink subframe and in which a third uplink subframe is scheduled, and the third uplink subframe is an uplink subframe that is in the first time segment and after the first uplink subframe and whose subframe number is closest to a subframe number of the first uplink subframe.

It should be noted that, the method for determining data transmission proposed in this embodiment of the present invention may be applied to a scenario in which the UE transmits the uplink data. When the UE sends the uplink data to the base station in the first uplink subframe, if the UE determines that the base station does not correctly receive the uplink data, the UE determines the CIF carried in the third downlink subframe that meets a scheduling relationship with the third uplink subframe, and determines, according to the CIF, the process ID for retransmitting the uplink data. The UE retransmits the uplink data in the third uplink subframe.

S2061. The UE determines, according to the process ID, to send the uplink data to the base station in the third uplink subframe.

The UE determines, according to the process ID, to send the uplink data to the base station in the third uplink subframe, after the UE sends the uplink data to the base station in the first uplink subframe, and if the UE determines that the base station does not correctly receive the uplink data, the UE determines the CIF carried in the third downlink subframe that meets the scheduling relationship with the third uplink subframe, and determines, according to the CIF, the process ID for scheduling the uplink data.

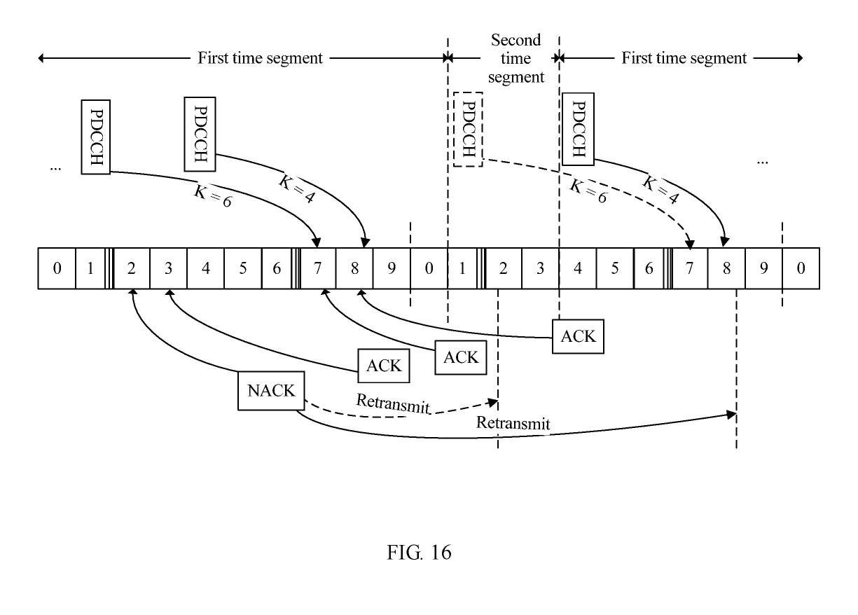

Exemplarily, as shown in FIG. 16, that the first uplink-downlink configuration supported by the current secondary component carrier is downlink:uplink=3:2 is used as an example. The UE sends the uplink data to the base station in the first subframe numbered 2, but the base station does not correctly receive the uplink data. Therefore, the UE needs to retransmit the uplink data in the second subframe numbered 2. It can be learned from FIG. 16 that, the second subframe numbered 2 belongs to the second time segment. Therefore, the UE cannot retransmit the uplink data in the second subframe numbered 2, which causes a delay of retransmitting the uplink data by the UE and affects communication efficiency. In this case, the method for determining data transmission provided in this embodiment of the present invention is used. It is assumed that the current subframe is the first schedulable uplink subframe that is after the second subframe numbered 2 and that belongs to the first time segment, that is, the third uplink subframe: a subframe numbered 8. The UE determines the CIF carried in the third downlink subframe that meets the scheduling relationship with the subframe numbered 8, that is, a subframe numbered 4, and determines the process ID of the uplink data according to the CIF. The UE may retransmit the uplink data according to the process ID in the uplink subframe numbered 8.

It may be understood that, when the base station does not correctly receive the uplink data sent by the UE, and the uplink data needs to be retransmitted, a schedulable uplink subframe that is closest to the subframe in which the uplink data is sent may be determined to retransmit the uplink data, thereby improving efficiency of data retransmission.

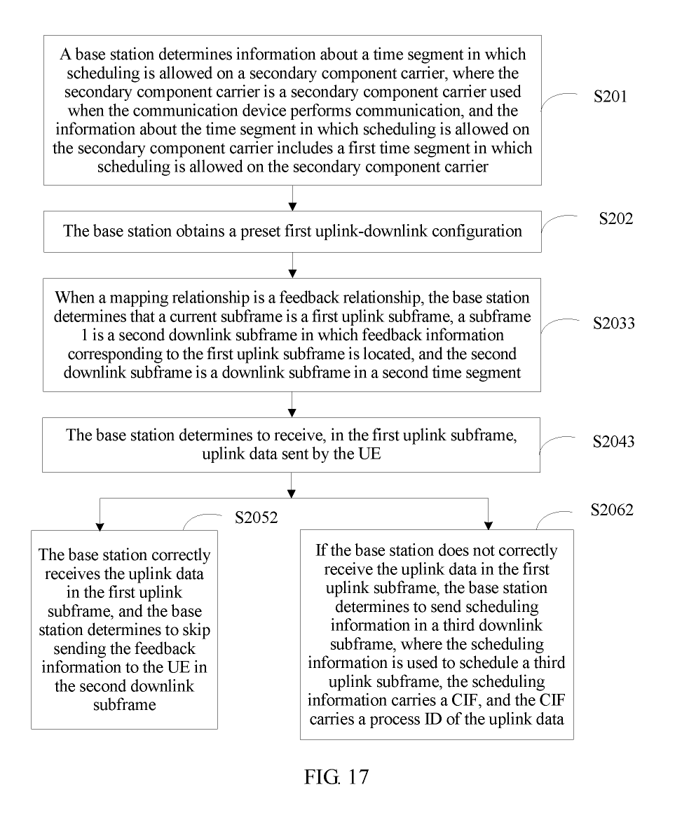

Further, as shown in FIG. 17, when the communication device is a base station, the foregoing S203 specifically includes S2033, S204 specifically includes S2043, and after S2043, the method for determining data transmission provided in this embodiment of the present invention further includes S2052-S2062, which are specifically as follows.

S2033. When the mapping relationship is a feedback relationship, the base station determines that the current subframe is a first uplink subframe, the subframe 1 is a second downlink subframe in which feedback information corresponding to the first uplink subframe is located, and the second downlink subframe is a downlink subframe in the second time segment.

When the mapping relationship is the feedback relationship, after the communication device obtains the first uplink-downlink configuration, the base station determines that the current subframe is the first uplink subframe, the subframe 1 is the second downlink subframe in which the feedback information corresponding to the first uplink subframe is located, and the second downlink subframe is a downlink subframe in the second time segment.

It should be noted that, in a process in which the base station transmits data, after receiving the uplink data in the first uplink subframe, the base station needs to send, in the second downlink subframe after the first uplink subframe, feedback information about whether the uplink data is normally transmitted, where the second downlink subframe is a subframe that meets the feedback relationship with the first uplink subframe.

Exemplarily, as shown in FIG. 9, that the first uplink-downlink configuration supported by the current secondary component carrier is downlink:uplink=3:2 is used as an example. It is assumed that the first subframe numbered 7 is the current subframe. The base station determines, according to the first uplink-downlink configuration and the first time segment, that the first subframe numbered 7 is the first uplink subframe in the first time segment, and the base station determines, according to the first uplink-downlink configuration, that the second downlink subframe in which the first subframe numbered 7 is fed back is the first subframe numbered 1 after the first subframe numbered 7. The base station determines, according to the second time segment, that the first subframe numbered 1 belongs to the second time segment.

It should be noted that, S2043 is executed after S2033.

S2043. The base station determines to receive, in the first uplink subframe, the uplink data sent by the UE.

When the mapping relationship is the feedback relationship, the base station determines to receive, in the first uplink subframe, the uplink data sent by the UE, after the base station determines that the current subframe is the first uplink subframe, the subframe 1 is the second downlink subframe in which the feedback information corresponding to the first uplink subframe is located, and the second downlink subframe is a downlink subframe in the second time segment.

It should be noted that, the base station may determine, according to the first uplink-downlink configuration, to receive, in the first uplink subframe, the uplink data sent by the UE.

S2052. The base station correctly receives the uplink data in the first uplink subframe, and the base station determines to skip sending the feedback information to the UE in the second downlink subframe.

After the base station determines to receive, in the first uplink subframe, the uplink data sent by the UE, if the base station correctly receives the uplink data in the first uplink subframe, the base station determines to skip sending the feedback information to the UE in the second downlink subframe, so as to end transmission of the uplink data.

It may be understood that, if the base station correctly receives the uplink data in the subframe 1, the UE does not need to retransmit the uplink data in an uplink subframe that has the same subframe number with the subframe 1 and is closest to the subframe 1, and therefore the base station may directly end the transmission of the uplink data.

S2062. If the base station does not correctly receive the uplink data in the first uplink subframe, the base station determines to send scheduling information in a third downlink subframe, where the scheduling information is used to schedule a third uplink subframe, the scheduling information carries a CIF, and the CIF carries a process ID of the uplink data.

After the base station determines to receive, in the first uplink subframe, the uplink data sent by the UE, if the base station does not correctly receive the uplink data in the first uplink subframe, the base station determines to send the scheduling information in the third downlink subframe, where the scheduling information is used to schedule the third uplink subframe, the scheduling information carries the process ID of the uplink data and a subframe number of the third uplink subframe, the third downlink subframe is a downlink subframe that is after the second downlink subframe and in which the third uplink subframe is scheduled, and the third uplink subframe is an uplink subframe that is in the first time segment and after the first uplink subframe and whose subframe number is closest to the subframe number of the first uplink subframe.

It should be noted that, after the base station does not correctly receive the uplink data in the first uplink subframe, the base station may determine to retransmit the uplink data in the third uplink subframe.

It should be noted that, S2052 and S2062 are two parallel steps after S2043. In this embodiment of the present invention, either S2043-S2052 or S2043-S2062 may be executed, which specifically depends on an execution condition.

This embodiment of the present invention provides a method for determining data transmission. If the communication device determines that a current subframe belongs to a first time segment, the communication device determines data transmission of the current subframe, where the first time segment is a time segment in which scheduling is allowed on a secondary component carrier, that is, a time segment in which a frequency resource is available. By determining that normal data transmission can be performed in all subframes in the time segment in which a frequency resource is available, the communication device ensures normal communication between a base station and UE, thereby improving communication efficiency between the base station and the UE.

It may be clearly understood by a person skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior aft, or all or some of the technical solutions may be implemented in the form of a software product. The computer software product is stored in a storage medium and includes several instructions for instructing a computer device (which may be a personal computer, a server, or a network device) or a processor (processor) to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A communication device comprising:
a processor configured to:
determine that a current subframe belongs to a first time segment, wherein the first time segment is a time segment in which scheduling is allowed on a secondary component carrier; and
determine data transmission of the current subframe.

2. The communication device according to claim 1, wherein the processor is configured to determine that the current subframe belongs to the first time segment, and a subframe 1 that meets a preset mapping relationship with the current subframe belongs to a second time segment, and wherein the second time segment is a time segment in which scheduling is stopped on the secondary component carrier.

3. The communication device according to claim 2, wherein the processor is further configured to obtain a preset first uplink-downlink configuration before the processor determines that the current subframe belongs to the first time segment and the subframe 1 belongs to the second time segment.

4. The communication device according to claim 3, wherein the mapping relationship is a scheduling relationship, and wherein the processor is configured to:
determine, according to the first uplink-downlink configuration, that the current subframe is a first uplink subframe and the subframe 1 is a first downlink subframe that meets the scheduling relationship with the first uplink subframe;
determine, according to the first time segment and the second time segment, that the first uplink subframe is an uplink subframe in the first time segment and the first downlink subframe is a downlink subframe in the second time segment; and
determine to transmit downlink data in the first uplink subframe.

5. The communication device according to claim 1, wherein the processor is configured to:
determine that the current subframe is a first subframe in the first time segment;
set a subframe number of the first subframe to a preset second subframe number, wherein the second subframe number is used to represent that the first subframe or a subframe 1 that meets a preset mapping relationship with the first subframe belongs to the first time segment; and
determine data transmission of the first subframe according to the second subframe number.

6. The communication device according to claim 5, wherein the processor is further configured to obtain a second uplink-downlink configuration before the processor determines the data transmission of the current subframe; and
determine the data transmission of the first subframe according to the second subframe number and the second uplink-downlink configuration.

7. The communication device according to claim 1, wherein the processor is further configured to:
before determining the data transmission of the current subframe, obtain a second uplink-downlink configuration;
determine that the current subframe is a first subframe in the first time segment, and
determine data transmission of the first subframe according to the second uplink-downlink configuration.

8. The communication device according to claim 2, wherein the communication device is a user equipment (UE) and the mapping relationship is a feedback relationship, wherein the UE further comprises a transmitter, wherein the transmitter is configured to send uplink data to a base station in a first uplink subframe determined by the processor, and store the uplink data in a transmission cache, and wherein the processor is configured to:
determine, according to the first time segment and the second time segment, that the first uplink subframe is an uplink subframe in the first time segment and a second downlink subframe is a downlink subframe in the second time segment; and
determine that the base station correctly receives the uplink data sent by the transmitter.

9. The communication device according to claim 8, wherein the processor is further configured to:
after determining that the base station does not correctly receive the uplink data sent by the transmitter, determine a carrier indicator field (CIF) carried in scheduling information that is received in a third downlink subframe, wherein the CIF carries a process ID of the uplink data; and
determine, according to the process ID, that the transmitter sends the uplink data to the base station in the first uplink subframe, wherein the third downlink subframe is a downlink subframe that is after the second downlink subframe and in which a third uplink subframe is scheduled, and wherein the third uplink subframe is an uplink subframe that is in the first time segment and after the first uplink subframe and whose subframe number is closest to a subframe number of the first uplink subframe.

10. The communication device according to claim 2, wherein the communication device is a base station and the mapping relationship is a feedback relationship, and wherein the processor is configured to determine that the current subframe is a first uplink subframe, the subframe 1 is a second downlink subframe in which feedback information corresponding to the first uplink subframe is located, and the second downlink subframe is a downlink subframe in the second time segment.

11. The communication device according to claim 10, wherein the base station further comprises a receiver, and wherein the processor is further configured to determine to skip sending the feedback information to an UE in the second downlink subframe after the receiver correctly receives uplink data in the first uplink subframe.

12. The communication device according to claim 10, wherein the processor is further configured to determine that a transmitter sends scheduling information in a third downlink subframe if a receiver does not correctly receive uplink data in the first uplink subframe, and wherein the scheduling information is used to schedule a third uplink subframe, the scheduling information carries a CIF, and the CIF carries a process ID of the uplink data.

13. A method for determining data transmission, the method comprising:
determining, by a communication device, that a current subframe belongs to a first time segment, wherein the first time segment is a time segment in which scheduling is allowed on a secondary component carrier; and
determining, by the communication device, data transmission of the current subframe.

14. The method according to claim 13, wherein determining that the current subframe belongs to a first time segment comprises determining, by the communication device, that the current subframe belongs to the first time segment, and a subframe 1 that meets a preset mapping relationship with the current subframe belongs to a second time segment, and wherein the second time segment is a time segment in which scheduling is stopped on the secondary component carrier.

15. The method according to claim 14, further comprising, before determining that the current subframe belongs to the first time segment, and a subframe 1 that meets the mapping relationship with the current subframe belongs to the second time segment, obtaining, by the communication device, a preset first uplink-downlink configuration.

16. The according to claim 15, wherein the mapping relationship is a scheduling relationship, wherein determining, by the communication device, that the current subframe belongs to the first time segment, and the subframe 1 that meets the mapping relationship with the current subframe belongs to the second time segment comprises determining, by the communication device according to the first uplink-downlink configuration, that the current subframe is a first uplink subframe and the subframe 1 is a first downlink subframe that meets the scheduling relationship with the first uplink subframe; and determining, according to the first time segment and the second time segment, that the first uplink subframe is an uplink subframe in the first time segment and the first downlink subframe is a downlink subframe in the second time segment, and wherein determining the data transmission of the current subframe comprises determining, by the communication device, to transmit downlink data in the first uplink subframe.

17. The method according to claim 13, wherein determining that the current subframe belongs to the first time segment comprises determining, by the communication device, that the current subframe is a first subframe in the first time segment, and wherein determining the data transmission of the current subframe comprises:
setting, by the communication device, a subframe number of the first subframe to a preset second subframe number, wherein the second subframe number is used to represent that the first subframe or a subframe 1 that meets a preset mapping relationship with the first subframe belongs to the first time segment; and
determining, by the communication device, data transmission of the first subframe according to the second subframe number.

18. The method according to claim 17, further comprising, before determining data transmission of the current subframe, obtaining, by the communication device, a second uplink-downlink configuration, and wherein determining the data transmission of the current subframe comprises determining, by the communication device, the data transmission of the first subframe according to the second subframe number and the second uplink-downlink configuration.

19. The method according to claim 13, further comprising, before determining data transmission of the current subframe, obtaining, by the communication device, a second uplink-downlink configuration, wherein determining that the current subframe belongs to the first time segment comprises determining, by the communication device, that the current subframe is a first subframe in the first time segment, and wherein determining the data transmission of the current subframe comprises determining, by the communication device, data transmission of the first subframe according to the second uplink-downlink configuration.

20. The method according to claim 14, wherein the communication device is UE and the mapping relationship is a feedback relationship, wherein determining that the current subframe belongs to the first time segment, and the subframe 1 that meets the mapping relationship with the current subframe belongs to a second time segment comprises determining, by the UE, according to the first time segment and the second time segment, that a first uplink subframe is an uplink subframe in the first time segment and a second downlink subframe is a downlink subframe in the second time segment, and wherein determining the data transmission of the current subframe comprises:
sending, by the UE, uplink data to a base station in the first uplink subframe, and storing the uplink data in a transmission cache; and
determining, by the UE, that the base station correctly receives the uplink data.

21. The method according to claim 20, further comprising: after the UE sends the uplink data to the base station in the first uplink subframe and the UE determines that the base station does not correctly receive the uplink data, the method further comprises:
determining, by the UE, a carrier indicator field (CIF) carried in scheduling information that is received in a third downlink subframe, wherein the CIF carries a process ID of the uplink data, the third downlink subframe is a downlink subframe that is after the second downlink subframe and in which a third uplink subframe is scheduled, and the third uplink subframe is an uplink subframe that is in the first time segment and after the first uplink subframe and whose subframe number is closest to a subframe number of the first uplink subframe; and
determining, by the UE according to the process ID, to send the uplink data to the base station in the third uplink subframe.

22. The method according to claim 14, wherein the communication device is a base station, the mapping relationship is a feedback relationship, and determining that the current subframe belongs to the first time segment, and the subframe 1 that meets the mapping relationship with the current subframe belongs to a second time segment comprises determining, by the base station, that the current subframe is a first uplink subframe, the subframe 1 is a second downlink subframe in which feedback information corresponding to the first uplink subframe is located, and wherein the second downlink subframe is a downlink subframe in the second time segment.

23. The method according to claim 22, further comprising determining, by the base station to skip sending the feedback information to an UE in the second downlink subframe after the base station correctly receives uplink data in the first uplink subframe.

24. The method according to claim 22, further comprising determining, by the base station, to send scheduling information in a third downlink subframe if the base station does not correctly receive uplink data in the first uplink subframe, wherein the scheduling information is used to schedule a third uplink subframe, the scheduling information carries a CIF, and the CIF carries a process ID of the uplink data.
